(19) United States
(12) Patent Application Publication
(10) Pub. No.: US 2025/0101760 A1
(43) Pub. Date: Mar. 27, 2025

(54) SECURE WORK POD AND METHOD OF MAKING AND USING

(71) Applicant: Hollman Family Advisors, LLC, Irving, TX (US)

(72) Inventors: Travis Hollman, Dallas, TX (US); Rajat Agarwal, Irving, TX (US); Sue Hwang, Carrolton, TX (US); Mason Parks, Coppell, TX (US); Noel Torress, Flower Mound, TX (US)

(73) Assignee: Hollman Family Advisors,LLC, Irving, TX (US)

(21) Appl. No.: 18/816,801

(22) Filed: Aug. 27, 2024

Related U.S. Application Data
(60) Provisional application No. 63/547,655, filed on Nov. 7, 2023.
(60) Provisional application No. 63/539,866, filed on Sep. 22, 2023.

(51) Int. Cl. E04H 1/12; A47B 21/02; A47B 21/03; A47B 21/06; E05G 1/06

(52) U.S. Cl. CPC E04H 1/125; A47B 21/02; A47B 21/03; A47B 21/06; E05G 1/06; A47B 2200/0071; A47B 2200/0072; A47B 2200/0078; A47B 2220/13

(57) ABSTRACT

The present invention is a secure work pod that is a flexibly private, moveable, personal office. The secure work pod allows a user to have visual and acoustic privacy in an otherwise open workspace. The secure pod is constructed of flat panels that are constructed in a workspace by connectors that allow for 90-degree connections of the panels. Panels may have windows for visibility inserted in the front and back panels. The windows may have semi-glazed windows for privacy or may be left open. The work pod has an acoustic door that provides privacy for the user. The secure work pods can be organized into small layouts having a few pods or in large layout “neighborhoods” having multiple work pods.

### CROSS REFERENCE TO RELATED APPLICATIONS

This application claims the benefit of U.S. Provisional Application Nos. 63/539,866 filed Sep. 22, 2023, and 63/547,655, filed Nov. 7, 2023.

### STATEMENT REGARDING FEDERALLY SPONSORED RESEARCH OR DEVELOPMENT

Not applicable.

### TECHNICAL FIELD OF INVENTION

This invention relates to the field of modular personal workspaces.

### BACKGROUND OF THE INVENTION

Office buildings came into use in the 18^{th} century and widespread use increased over the next one hundred plus years as working outside the home began to be more common than in previous generations. In the first half of the 20^{th} century, office workspaces generally had a few individual offices for business managers situated around a large common work area. In the open work area, workers were generally placed in a factory line layout tightly packed together where supervisors could easily watch the room full of workers. In this time, the majority of the work was done by hand, and though open, the crowed workspace was relatively quiet. Over time the factory line desk configuration gave way to individual work desks positioned in an open office area.

With the advent of technology, such as typewriters and telephones, these open work areas became increasingly noisy. Cubicles were introduced in the 1960s originally to allow office workers to have a customizable private space to work with varying heights of work surfaces and acoustic materials to reduce the noise associated with workers using telephones and typewriters.

The idea of customizable private workspaces was not accepted by most companies, who saw cubicles instead as a way to pack workers closer together into small impersonal spaces, leading to the cubicle “farms” common in the 1970s and 1980s. Open concept offices became popular again in the dotcom era of the 1990s, however, with computers in addition to telephones and typewriters these areas became increasingly noisy and were distracting for workers.

For many office workers, the lack of privacy and the noise of nearby coworkers has been a source of stress and dissatisfaction whether in a cubicle or in an open concept workspace. The stress and noise can also lead to inefficiency and burnout for workers. Increasingly, much of the work done in offices today involves handling personal and financial data that requires a level of security that is difficult to achieve in an open office area. Additionally, much of the work performed in offices requires focused attention without distractions that is can be difficult to achieve in an open office area.

There remains a need for an individually functional work space that is easily constructible in an open office area that can foster productive efficiency and provide security, as well as affording visual and auditory privacy for workers in an office setting.

### SUMMARY

The present invention is a secure work pod comprising a moveable, personal office space and a method for making and using the secure work pods. The secure work pod has a plurality of exterior wall panels, said plurality of wall panels having a back wall panel, a right side wall panel, a left side wall panel and a front wall panel, said front wall panel being substantially half the length of the back wall panel and having a window opening; a plurality of interior wall panels, said plurality of wall panels having a back wall panel, a right side wall panel, a left side wall panel and a front wall panel, said front wall panel being substantially half the length of the back wall panel and having a window opening; a horizontal floor panel having a left side edge, a right side edge, a back side edge and a front side having an angled front edge and a straight front edge, said left side edge, said right side edge, said back side edge and said straight front edge being substantially perpendicular to one another; and a horizontal ceiling frame having a left side edge, a right side edge, a back side edge and a front side having an angled front edge and a straight front edge, said left side edge, said right side edge, said back side edge and said straight front edge being substantially perpendicular to one another.

The secure work pod has a channel framing structure having a plurality of construction connectors to attach the wall panels, floor panel and ceiling frame to the channel framing structure for construction of the secure work pod. the interior and exterior vertical front wall panels are positioned coplanar on the channel framing structure between the angled portion of the horizontal floor panel and the angled portion of the horizontal ceiling frame such that the front panels of the work pod are angled and the front wall panels are adjacent to either the panels on the right side or the panels of the left side, said angled front wall panel orientation providing visual privacy to the pod interior through the window in the front panels, and the interior and exterior back panels, right side panels and left side panels are coplanar and the vertical edges of the interior and exterior back panels, right side panels and left side panels are secured to the channel framing structure adjacent to one another having substantially perpendicular connections at the vertical edges. All of the wall panels are substantially of the same height being secured to the channel framing structure perpendicular to said floor panel and said ceiling frame. The ceiling is partially open with an acoustic panel secured to the horizontal ceiling frame.

There is a doorway opening encompassing the space between the angled front panel and the adjacent left side panel or adjacent right side panel, said half-length of said front panel providing said doorway opening adjacent to the front panel and a door positioned in the doorway opening and attached to the secure work pod. The doorway has a moveable door that opens and closes, and the moveable door may be a sliding door made of acoustic materials for sound regulation.

The secure work pod has a desk integrated into the interior of the work pod positioned between the angled front panel and the back panel, said desk being substantially parallel to the adjacent side wall. The integrated desk is vertically moveable for use in a seated or a standing position and horizontally moveable toward the secured chair.

The secure work pod has a chair secured to the horizontal floor panel, said chair having a stationary back member and a foldable seat member, said foldable seat member capable of being folded towards the stationary back member. The foldable seat member folds towards the stationary back such that the front edge of the seat member and the top edge of the stationary back member form a seating platform for a user.

There is a control panel attached to the back wall panel of the secure work pod housing controls for environmental conditions in the work pod. The secure work pod has drop in wiring connectors to provide power to the pod interior.

The exterior wall panels of the secure work pod comprise a single vertical panel, a plurality of adjacent vertical panel sections or a plurality of adjacent horizontal panel sections that are changeable and replaceable. One or more of the window openings of the secure work pod have glass windowpanes, plastic windowpanes, or switchable smartglass windowpanes in the openings.

The secure work pod has locking casters on the bottom for moving the work pod and to secure the work pod in position and connectors positioned on the exterior panels to securely connect one or more pods together in a multi-pod work layout.

In some embodiments, a triangular shaped compartment is removably secured to the exterior angled front panel underneath the window opening. The triangular shaped compartment has an integrated storage area and a removable top tray portion and is sized such that the front edge and side edge of the triangular shaped compartment are coextensive and perpendicular to the edges of the adjacent wall panels.

A method of constructing a secure work pod of the present invention has the steps of: providing a channel framing structure having interior facing and exterior facing portions with a plurality of construction connectors positioned on the members for fastening interior and exterior panels to the framing structure, said framing structure having vertical members for securing vertical wall panels, top horizontal members for securing a ceiling frame at the top of the frame and bottom horizontal members for securing a floor panel; providing a horizontal floor panel having a front edge with an angled portion and a straight portion, and having perpendicular edges on the right side, left side and back side of the floor panel; providing a horizontal ceiling frame having front edge with an angled portion and a straight portion, and having perpendicular edges on the right side, left side and back side.

The method steps include providing a plurality of exterior wall panels, said plurality of exterior wall panels having a back wall panel, a right side wall panel, a left side wall panel and a front wall panel, said front wall panel having a window opening and being substantially half the length of the back wall panel providing a doorway opening on the front of the secure work pod; providing a plurality of interior wall panels, said plurality of interior wall panels having a back wall panel, a right side wall panel, a left side wall panel and a front wall panel, said front wall panel having a window opening and being substantially half the length of the back wall panel providing a doorway opening on the front of the secure work pod coplanar with the doorway opening the exterior front wall panel; providing drop in electrical components to provide power to the secure work pod interior;

The method steps include securing the horizontal floor panel to the bottom horizontal members of the frame structure with the construction connectors; securing the horizontal ceiling frame to the top horizontal members of the frame structure with the construction connectors; attaching the interior wall panels to the interior facing portion of the frame structure. The method steps include attaching the drop-in wiring connectors to the back panel adjacent to a location for a power outlet strip for the work pod interior for powering lights and equipment; and attaching the exterior wall panels to the exterior facing portion of the frame structure using the construction connectors.

The method further has the steps of installing one or more windowpanes in the window opening, said windowpanes being glass windowpanes, plastic windowpanes, switchable smartglass windowpanes, or a combination thereof, and installing a moveable door in the doorway opening of the front panel that opens and closes. In the method the moveable door is a sliding door made of acoustic materials for sound regulation, said sliding door having top and bottom tracks for opening and closing movement of the door, said sliding door when closed is positioned adjacent to the front panel and the sliding door when opened is positioned inside the secure work pod behind the user along the side wall.

Also disclosed is a method for structuring a secure work pod environment with the steps of: providing a plurality of assembled secure work pods, each of said plurality of assembled secure work pods having a ceiling frame, a ceiling panel, or a combination thereof; a floor panel, said floor panel having a plurality of lockable casters for moving and securing said assembled secure work pod, a front side with a window opening, a left side, a right side, and a back side, said front side, back side, left side and right said having wall panels, said front side being positioned at an angle relative to either the left side or the right side of the secure work pod, and a doorway opening adjacent the angled front side.

The method includes providing construction connectors on the exterior of the plurality of secure work pods; providing one or more banks of lockable storage compartments, said banks of lockable storage compartments having construction connectors compatible with construction connectors on assembled secure work pods; positioning said assembled secure work pods adjacent to one another such that said angled front side with said window opening of a first secure work pod is directed away from said angled front sides with said window openings of one or more adjacent work pods, said positioning providing visual privacy for the secure work pod interiors. The method continues with connecting assembled secure work pods with said construction connectors on said left side, said right side, or said back side to construct a secure work pod cluster having two or more secure work pods with windows angled to provide for visual privacy; and connecting said one or more banks of lockable storage compartments with said construction connectors to one or more of the secure work pods in the work pod cluster forming a work pod block.

Two or more work pod clusters or work pod blocks are positioned to provide visual privacy for each secure work pod front window and to facilitate access for users to one or more of said connected lockable storage compartments. The secure work pod clusters or work pod blocks are organized around a common use area in a workplace environment. One or more lockable storage compartments in said one or more banks of lockable storage compartments have electronic locks with accessibility that can be assigned to a user on a short term or a long-term basis. The method further includes providing lockable sliding doors in the doorway openings of the assembled secure work pods, said sliding doors being made of acoustic materials for sound regulation and providing ceiling panels having acoustic materials for sound regulation in the secure work pods.

### BRIEF DESCRIPTION OF THE DRAWINGS

The above, and other objects and advantages of the present invention will be understood upon consideration of the following detailed description taken in conjunction with the accompanying drawings, in which like reference characters refer to like parts throughout, and in which:

FIG. 1 shows a front perspective view of a secure work pod exterior.

FIG. 2 shows a rear perspective view of the secure work pod exterior.

FIG. 3 shows a bottom perspective view of a secure work pod.

FIG. 4 shows another front perspective view of a secure work pod exterior.

FIG. 5A shows a view of the work pod with intact acoustic side panels.

FIG. 5B shows an exploded view of the acoustic side panels for the work pod.

FIG. 5C shows an enlargement of the acoustic panels and attachment.

FIG. 6A shows a work pod with the sliding acoustic door in the closed position.

FIG. 6B shows a work pod with the sliding acoustic door in the open position.

FIG. 6C show an enlargement of the bottom portion of the acoustic door.

FIG. 6D show an enlargement of the top portion of the acoustic door.

FIG. 7A shows a field of view angle for the work pod.

FIG. 7B shows the view from the interior of the work pod.

FIG. 7C shows the view into the work pod from the outside.

FIG. 8A shows an interior and lighting in a secure work pod.

FIG. 8B shows interior lighting components.

FIG. 8C shows placement of interior lighting.

FIG. 8D shows a control console in the work pod.

FIG. 9A shows a work pod interior with desk extended.

FIG. 9B shows a work pod interior with desk closed.

FIG. 9C shows a work pod chair in the open position.

FIG. 9D shows a work pod chair in the closed position.

FIG. 9E shows a work pod interior with the desk and chair.

FIG. 10 shows a multi-pod neighborhood layout.

FIG. 11 shows a locker bank for a work pod neighborhood.

### DETAILED DESCRIPTION

Disclosed herein is a secure work pod that is a flexibly private, moveable, personal office. The secure work pod allows a user to have visual and acoustic privacy in an otherwise open or cubicle-based workspace. The secure work pod is constructed of flat panels having one or more panels on a front side, one or more panels on a back side, one or more panels on a left side, one or more panels on a right side, a bottom panel, and optionally, a top panel. The panels are constructed in a workspace by construction connectors that allow for 90-degree connections of the panels. Panels may have windows for visibility inserted in the front and back panels. The windows have semi-glazed windows for privacy, or in some configurations, the windows may be left open.

Secure Work Pod with Flex Integration The secure work pod has a plurality of flexible features integrated into the work pod that function to provide a comfortable, secure, and private workspace for an individual user in a multi-user working environment. Features that create a secure working environment include a sliding acoustical door, an angled front view window with switchable smartglass, and an acoustical ceiling. Features that enhance a comfortable working environment include an integrated sit/stand desk, an integrated foldable chair, tunable graze lighting, integrated audio components, and storage space for personal belonging inside the work pod. The secure work pod supports drop in wiring connectors to provide power to the pod interior for components that require electricity, such as lighting and computers, and allowing for data security features within the secure pod.

The secure work pods can be easily constructed on site and moved or repositioned across flat surfaces using the integrated casters. The secure work pod can also be moved using a forklift or pallet jack. The secure work pods can be organized into small or large neighborhood-type configurations with the pods oriented to provide visual privacy to users. The orientation of the pods to provide visual privacy allows for data security and on-screen privacy within the secure work pod keeping sensitive information such as passwords and client data more secure than is possible in an open office layout. Neighborhoods can also have common use areas which provide a community feeling to the neighborhood of secure work pods.

The disclosed secure work pod has a user controlled interior environment. Mobile enclosures typically lack climate control, and many warehouses and workshops do not feature climate-controlled environments. In extreme weather conditions, using a laptop or doing paperwork in an area without climate control can prove difficult, which hinders productivity and accuracy of work. The climate-controlled environment of the secure work pod provides a comfortable working location for floor supervisors.

Top-mounted air conditioning and heating systems for the secure work pods are easy to use. The air conditioning and heating system cools and heats the small space quickly and quietly. The enclosed system requires little to no maintenance. Having a place to cool down or warm up during harsh seasonal temperatures creates a comfortable working environment. The climate system controls are located inside the interior of the unit and the temperature and air flow settings can be tailored to the individual user. The system may also utilize a non-filter purification means inside the pod, such as Ultra-Violet (UV) lights or other means. The secure work pod supports drop in wiring connectors to provide power to the pod interior.

Aluminum Channel Edging and Construction Clip Assembly. The secure work pod has an aluminum channel edging framing support that provides construction support. The aluminum channel edging also provides an aesthetic feature that finishes corners and provides rigid support to the wooden frame. The pod exterior structure is constructed by utilizing routed insert construction connectors that allow for quick 90° connections, as well as a construction clip system that quickly and easily allows the installer to clip the acoustic panels to the frame. Some embodiments may lack construction inserts and clip systems and the panels are secured by other means, such as bolts.

Modular Functional Panels. The secure work pod uses modular functional panels available with a multitude of finish options and which can be easily replaced. The secure work pod system is adaptable and can be used with various types of materials for the panels, such as& polyethylene terephthalate (PET) panels, laminated panels, and wood veneer panels for both the interior and exterior of the unit. Multi-material options are usable for the panels including, but not limited to: PET, PET Fabric, High Pressure Laminates (HPL), Wood Veneer, and Vinyl Wrapped Panels. With the impermanent interior and exterior paneling, ruined or disliked panels can be replaced as needed. Ease of installation may be achieved with a single-user attachment clip system for attaching the panels to the frame. The panels are removed and installed by hand. A clip system allows a single user to ‘snap’ the panels onto the unit frame using the integrated connection points.

The transient nature of these panels offers unparalleled versatility, allowing spaces to be reimagined and transformed in response to changing needs or aesthetics. Layers of texture, color, or pattern can be added or altered at will. This modular property of the panels facilitates efficient maintenance, as removal of the panels grants easy access to underlying systems and promotes sustainability by minimizing waste and resource consumption. The panels can be easily replaced or repurposed, reducing the environmental impact of renovations. This innovation speaks to a new era of design, where adaptability, sustainability, and aesthetics converge to shape the workspaces into fluid expressions of users' ever-evolving needs and aspirations.

The modular panels can be made of impact resistant materials and replaceable panels are also available in materials to suit various environments. The panels can be fully replaceable, durable, impact resistant panels for high-traffic, high-wear locations. The impact resistant panels surround and protect the structural integrity of the unit, prolonging the life of the secure work pod. Impact resistant panels also offer additional durability for the housing of devices, structures, enclosures, and equipment when placed in an environment that is subject to frequent wear. Panels can be easily replaced as needed if worn or damaged. In some embodiments, a bolt system can be used to secure panels in place by using a socket wrench which simplifies the process of removal and replacement.

Planter Box with Integrated Storage Compartment. The secure work pod frame includes an angled front corner in the unit which has a panel with a window opening. In some embodiments of the work pod, this angled front area has a storage compartment positioned beneath the window on the exterior of the angled front panel. This storage compartment may house an external planter box on top fitted with biophilia and a removable planter tray. An access control system and smart lock may be integrated into the storage compartment or planter box. In some embodiments, units may lack built-in or linked storage features. In some embodiments the storage compartment is approximately 15 inches deep by×15 inches high and 15 inches wide. The planter tray is removably positioned on the top of the compartment.

Partially Open Ceiling Grid. The secure work pod has an open top dimensioned to accommodate an acoustic PET ceiling enclosure compatible with a drop-in fire sprinkler system. In some embodiments, option baffled ½ inch PET strips may be cut in an elongated ‘T’ pattern and laid across the work pod top allowing the top to be partially open. In some embodiments the ceiling may be about 70% open. In some embodiments, the ceiling panel has a custom cut-out design allowing additional ventilation and introduction of ambient light from outside of the work pod. In some environments, it may be preferable for the ceiling to be completely closed. In some embodiments, the work pod may lack enclosed or partially enclosed ceilings. For some units, the ceiling is only used when the product is folded up. For some units, the ceiling is not designed for fire sprinkler compatibility or affixed with PET for acoustic suppression. The open, partially open, or closed nature of the ceiling can be altered to be compliant with local fire code and to best suit the environment where the work pod is used.

Forklift/Pallet Jack Mobility. The secure work pod has a custom-designed integrated base lift platform attached to the base of the unit allowing it to be easily transported by a forklift or pallet jack from two different directions. A sheet metal construction base lift platform attached to the bottom offers stability during transportation. The base contains cushion-like elements which absorb impact and assist in levelling the unit. The reinforcements also guard the bottom of the unit from forklift damage. The integrated base lift platform ensures that forklift pickup and transport is placed in optimal locations to avoid catastrophic damage such as dropping the unit.

When the unit can be transported with standard forklifts and pallet jacks by using the custom designed base platform, current moving challenges are resolved such as uneven terrain in warehouse floors, transporting pods long distances, and transportation to and from site during shipping. The logistics for transporting the secure work pod are streamlined and simplified while omitting potential errors and damage. The forklift pallet jack mobility reinforcements can easily be implemented allowing the user to move the unit using standard equipment that may already be available in the work environment. Indicators on the sides of the unit signal applicable lifting points for the forklift or pallet jack to follow when loading the unit for transport.

Sliding Acoustic Door. The user experiences visual and acoustic privacy assisted by a sliding acoustic door that travels along channels routed into the frame and covers the entire accessible entry space when in use. In some embodiments there may be standard hinge-hardware doors, or the work pods may lack enclosing systems altogether.

An acoustically furtive sliding door gives a user complete freedom as to the level of privacy needed to be productive while in the unit. The door is a custom engineered product made from mass-loaded vinyl (MLV), sandwiched between two layers of acoustic polyethylene terephthalate (PET). The door sits inside a channel cavity on the frame and slides via roller bearings to provide an opening to the unit.

The acoustic door tracks internally inside the unit within the channel integrated in the frame. The acoustic door can be fully or partially closed by the user as needed. The door is fabricated using a combination of custom polyethylene terephthalate (PET) at specific angles with mass loaded vinyl. The door is flexible enough to be able to rotate inside the door channel and be stored out of the user's way.

The acoustic door allows a user complete freedom as to the level of acoustic and visual privacy they need to be productive in the unit. This freedom revolutionizes the way privacy and tranquility may be experienced within workspaces. With the level of privacy variable, the user is in control, allowing a balance between openness and seclusion, while effortlessly adapting to changing needs. Elevating functionality to an art form, this acoustic door can use custom material construction, empowering the user to curate an aesthetic that perfectly complement the user's style and architectural preferences.

In the closed position, the acoustic door sits flush with the adjacent wall and provides acoustical privacy for the user. To initiate opening the door, the user applies pressure to the handle to push the door along its track, moving the door from the closed to the open position. During its travel, the door can be stopped at any point along the track. The door remains securely in place without any risk of unintended movement, which allows the door to be left partially open. To fully open, the user continues to apply pressure to the handle until the door has traveled the entire length of the track to the stop position.

The acoustic door can be a pocket door that is concealed when not in use and can remain open while not impeding additional space around the work pod. The acoustical door can be made lockable. The lockable pocket door gives the user the option to protect personal belongings and management tools within the unit, and the pocket door feature minimizes the footprint when concealed. The pocket door is fabricated with sturdy construction to withstand a harsh environment such as a warehouse or outdoor setting.

The sliding acoustic door is made of acoustic PET and runs along a channel in the frame, guiding it to slide shut in front of the accessible entrance. The door will slide open towards the back of the interior space. No hinges are involved in doors with the sliding mechanism. In some embodiments, the work pod door may have a hinged door which swings outward to open instead of a sliding door. A hinged door may still comprise acoustic materials and be lockable.

Visual Privacy. The secure work pod unit features visual privacy. The exterior walls of the pod act as a visual barrier providing privacy for the user inside of the pod. The work pod unit is designed to give a user the capacity for visual privacy to eliminate distractions and foster a sense of comfort. The secure work pod has an angled front window on the front (door) side of the pod adjacent to the work desk to allow the user to see out of the pod while working at the desk, even if the door is closed. Incorporating angled window panels into the pods not only allows a user to have a view outside of the pod, but the angled windows also allow for the windows in a group of pods in a work environment to be oriented in such a way that the users in the group of pods will each have visibility outside of the pod without having a view into another pod. The angled front view window may be fitted with switchable smartglass to provide additional visual privacy for the work pod. Switchable smartglass allows the user to change the windowpane from the usual transparent appearance to a translucent or opaque appearance as needed for privacy. The work pod unit is designed to give an individual user the comfort of visual privacy while supporting the visual privacy of other workers in the area.

The angled window of the work pod unit offers privacy from all common passerby views. The window offers a viewport of immediate surroundings for the user promoting a peripheral sense of openness and avoiding claustrophobic feelings. This creates the visual perception of being part of a workplace community and ecosystem. The view port window panel is designed to hide sensitive material within the work pod without sacrificing user view out of the window. The orientation of the pods to provide visual privacy allows for data security and on-screen privacy within the secure work pod keeping sensitive information such as passwords and client data more secure than is possible in an open office layout.

The secure work pod unit stands as a shield that nurtures focus, creativity, and personal well-being within the modern world's bustling workspaces. With the visual and acoustic privacy features, confidential discussions can unfold in a secure atmosphere, fostering an environment of trust and open communication. This sense of seclusion cultivates a space for introspection and rejuvenation, allowing individuals to recharge and maintain a healthy work-life balance. Visual privacy enhances concentration, enabling individuals to delve deep into their work without being drawn away by surrounding activities. The advantages of visual privacy extend beyond the surface, shaping both individual experiences and the collective fabric of harmonious coexistence. The user is inherently offered visual privacy during their use of the product but can manually increase or decrease the levels of acoustic and visual privacy with built-in features.

Partial Back Window. The secure work pod unit features a semi-glazed window on the opposite side wall from the entrance to allow more natural light to enter the work pod while still providing visual-privacy for the user. In some embodiments, the back window may be left open without a windowpane.

Indirect Lighting-Graze or Wall Washing. The work pod has a source of light incorporated within the unit. In some embodiments, the user and workspace on the interior of the unit are illuminated primarily by indirect graze-type lighting integrated along adjacent walls. The graze-type lighting has LED lights positioned inside reflective panels and the light emitting from under the panels illuminates the area without harsh direct light inside of the work pod interior. Another type of indirect lighting that may be used in the work pods is wall-washing type lights which use angled recessed lighting to direct light toward the wall surface and away from the desk surface. Using indirect lighting inside of the work pod helps prevent the eye strain that can occur when direct lighting is used in a small space. In some embodiments the work pods may incorporate lighting that either serves a different function than to illuminate the workspace or lighting that shines directly onto the work surfaces.

Lighting for the secure work pod may incorporate combinations of Graze Lighting, Diffused Lighting and Tunable RGBW Lighting. RGBW (red, green, blue, and white) is full spectrum lighting. Indirect lighting improves the environment appearance by preventing harsh shadows and reduces eye strain. The indirect lighting combinations complete a non-obstructive halo effect within the unit to create balance and harmony.

When the lighting within the secure work pod is tunable, the user is able to change the interior ambient LED lighting to their desired color. The light tuning is through a light controller on the pod's integrated control panel, giving the user the ability to adjust the mood within the unit. In some embodiments the work pods may not include tunable user-controlled lighting.

With tunable lighting, the user has control over color, tone, and brightness of the lights. The user is not directly exposed to bright light which improves visual acuity and reduces eye strain. Flexibility in color temperature, intensity, and distribution allows the user to evoke specific moods or create functional zones within the workspace. The lighting aligns with energy efficiency goals, enabling the user to optimize the use of light where and when needed. The lighting grants the freedom to shape the workspace environment in ways that standard lighting cannot, turning each unit into a uniquely crafted space of both form and function. The tailored illumination caters to the users' specific tasks and preferences, ensuring optimal lighting conditions that reduce eye strain and enhance focus, which contributes to a more inviting and inspiring atmosphere that enhances the overall work experience.

To power on, the user selects the power icon on the touch controller. The user can interact with the touch controller interface by tapping or sliding to navigate through the spectrum of RGBW (red, green, blue, and white) colors. As the user's finger moves across the controller surface, the corresponding color is dynamically displayed on the LED fixtures. The user can control the brightness level by touching and holding on the brightness icon of the controller. This action dims or brightens the selected color, allowing for precise illumination control. As the user interacts with the touch controller, the LEDs provide real-time feedback by instantly adjusting to the selected colors and intensities. This immediate response enhances the tactile experience.

Do Not Disturb (DND) and Digital Signage. Another lighting feature for some embodiments of the secure work pod is a light signal that allows the user to indicate when the user wishes not to be disturbed. A light signal on the pod shows up as red at the top when a user is in “do not disturb” mode. When a user is in “approach only if necessary” mode the light will turn yellow. When a user is in “you are welcome” mode the light will turn green. Lights are user controlled with a control switch or can be tied to occupancy sensor which automatically changes the color light as a user occupies the work pod. Another lighting feature for the work pod is a nameplate with digital signage that can be personalized with the user's name or other information which can be useful in work environments using hot-desking or desk hoteling wherein workspaces may be used or assigned on an as needed or rotating basis.

Box Control Center with Arm Rest. A control center for the lighting features is constructed within the wall of the unit where all device controllers, hubs, and device connections are integrated. The box controller is accessible via a pod access panel post installation. Lighting and audio systems may be controlled from the control center. The control center is constructed within the wall of the unit also has a top surface that serves as an arm rest.

Desk and Chair Combination. The Workspace has a Hybrid Desk and Chair Combination integrated into the work pod frame system. This unique setup lets a user adjust the desk both in vertical and horizontal directions via a motorized lift for the desk. A footrest is anchored to the floor panel beneath the pullout/sit-stand desk. Footrest materials may include Acrylonitrile Butadiene Styrene (ABS) and Polyvinyl Chloride (PVC). Some work pod embodiments may lack footrest integration allowing for customizable footrest options for users.

Folding Sit/Stand Chair. A lounge office chair which allows a user to fold the seat to facilitate the ideal space for a standing work position. The chair comes designed with an integrated foldable seating platform with alternate storage underneath it. Personal storage is accessible only from inside the interior space and sits behind the user, providing both lockable enclosed storage options and open-box display options.

A fixed seating system allows users the combination option to sit down and/or stand up without moving the chair from its static position. A self-folding seating system is designed to work in conjunction with the desk system which ergonomically moves based on individual user profile. The bottom structure of the seat front edge is designed to work with the seat back edge as a ledge to support the user in a standing position.

Audio Integrated into Headrest. The secure work pod optionally has a seating solution with a crescent-shaped headrest that encloses the user's immediate hearing space in a low-level audio bubble. The audio bubble allows music, voice, or white noise to be played in a localized area around the user's head without disturbing others in the surroundings. In some embodiments there may be headrests without audio function, or the design may not include audio options altogether.

The ergonomic design of both the desk and chair elements promotes proper posture, reducing the risk of discomfort and strain during extended work periods. There is seamless compatibility—the desk and chair are designed to complement each other, ensuring optimal ergonomics and a cohesive aesthetic. This integrated setup eliminates the problem of searching for a suitable chair that fits the desk's height and design. The desk-chair setup saves valuable space in the work pod, making it a smart choice for compact environments. The ease of assembly and consistent design language further streamlines the setup process, leaving users with more time to focus on tasks. The desk and chair combo redefines workspaces, elevating comfort, efficiency, and aesthetics in a single, ingenious package.

The sit/stand desk also features a pull-out undermounted extendable surface to increase usable surface area when in a seated or standing position. The user can manually pull out the under-desk which serves as an extension. The desk itself is also motorized with a controller giving the user the choice to adjust the height of the desk for the user's comfort. This includes raising the desk for a standing work function as well. In some embodiments work pods may lack a sit/stand desk and/or an under-desk extension.

The desk height is electronically controlled with a button system on the desk surface. The desk's lateral position is controlled by manually sliding the surface forward and back to whatever position the user desires. The seat rotates about its axis, providing easy access when entering the unit. By default, it folds up clamshell-style. When the user desires to sit, they can press on the seat to open the chair like a stadium seat. The seat is held in the open position while the user is seated in the chair. All desk mobility options are accessible from both seated and standing positions.

Write/Erase Desk Surface. In some embodiments, the desk has a laminate or wood veneer desktop which may be treated with gloss thus enabling clean erasure of whiteboard-type markers. Some embodiments may lack writeable surfaces.

Wireless Charger Integration. The desk system has a custom hardware setup that provides the desk with the dual abilities of combination height and pullout adjustable features. The desk system has fully integrated power and connectivity for integrated equipment and for charging electronics. A concealed or non-concealed wireless charging dock is integrated in the upper right-hand corner of the sit/stand workstation. In some embodiments the desk may lack the wireless charging feature.

Neighborhood Ecosystem. The modular nature of the secure work pods allows for an integrated design that is flexible and allows for the replacement of traditional cubicle structure. The work pods can be organized into semi-private “pod neighborhoods” inclusive of a workplace community or team having a shared common space within the same footprint. The work pod neighborhoods may be connected to smart storage structures and open seating areas and may have conveniently located trash receptacles in the amenity space within the neighborhood.

Work Pod with Storage Integration. In the work pod communities, units have the on-demand privacy pods integrated with wood locker storage having an RFID access control system. The locker towers are designed to work cohesively with the work pods, and in one example, towers may be about 72 high to be situated below the ceiling height of the work pods. The storage compartments are sized to integrate into the work pod areas and keep a small footprint in the common area. Compartments may optionally be about 15 inches wide by 18 inches deep to keep the footprint small, though larger and smaller sized compartments are also envisioned. Smaller compartments may be needed in areas with a number of users rotating through the workspace and larger compartments may be needed in work environments requiring more vertical storage space for coats, clothing, or equipment. Locker towers may have, for example, 2 to 4 openings and have storage for a particular work pod set having 2 to 4 work pods. Larger work pod communities would require more compartments and locker banks depending on the size of the community. Some embodiments may lack built-in or linked storage features depending on the work environment.

Integrated Locker System. The secure work pods can also incorporate integrated smart locker systems to complement and enhance user experience and be part of the neighborhood ecosystem. The integrated locker system of the disclosed invention is a fully mobile, integrated, RFID controlled, public access locker system for personal belongings. The integrated, RFID controlled locker system is attachable and may be secured to one or more of the secure work pods. The integrated smart locker systems are configurable for device and asset management, as well as personal and company storage, and housing for equipment and personal protection equipment (PPE).

The integrated locker system works in tandem with hot desking and desk hoteling to allow for flexible, on-demand personal locker storage for occupants. The locker compartments can be assigned on an as needed or permanent basis. The locker system keeps personal belongings as well as company assets locked and organized and serves as a hub for the organization of company devices and tracking of their use. The configurable integrated locker systems can be used as needed and can be integrated into the existing company booking system for lockers.

Users can electronically book a locker for a length of time that is monitored and approved by management. Users can set a temporary numerical passcode to secure their belongings. Additionally, management can configure lockers to house electronically locked charging stations for company devices, slotted equipment organizers, or for lockable personal storage.

The objects and advantages of the present invention described above will be understood upon consideration of the following detailed description of the figures, in which like reference characters refer to like parts throughout.

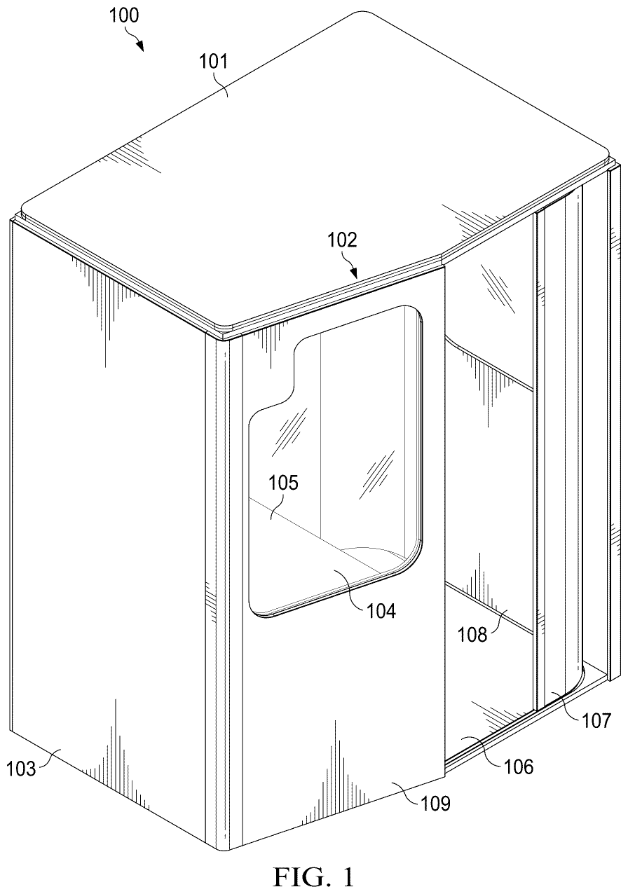

FIG. 1 shows a front perspective view of a secure work pod exterior and provides a basic overview of the work pod 100. The work pod 100 has a ceiling 101 that may be fully open with framing, partially open, or fully enclosed. FIG. 1 shows the work pod with a fully enclosed ceiling 101. The ceiling is constructed of acoustic material to provide sound control. The angled edge 102 on the ceiling corresponds to the shape of the work pod. The work pod is constructed with exterior and interior panels. FIG. 1 shows an exterior side panel 103. Exterior panels used in the work pod construction may be single panels on each side as seen with the panel 103 in FIG. 1 or the sides may have several smaller modular exterior panels to suit a desired design or aesthetic for the work pod environment. The exterior panels are made of acoustic materials, such as PET for sound control. The pod has an angled front panel 109 adjacent to the angled ceiling edge 102. The angled front panel 109 has a window 104 that may be left open or may have a windowpane. The windowpane may be a clear pane or a switchable privacy smart-glass pane. The work pod has a door 107, and the door shown in FIG. 1 is a sliding pocket door. In some work pod embodiments, the door may be a hinged door rather than a sliding door.

Also shown in FIG. 1 are interior features of the work pod. The work pod has an integrated desk 105 that may be a sit/stand adjustable desk. The work pod has a floor panel 106 and interior acoustic panels 108. Interior panels may be single panels or may be multiple modular panels as seen in this figure.

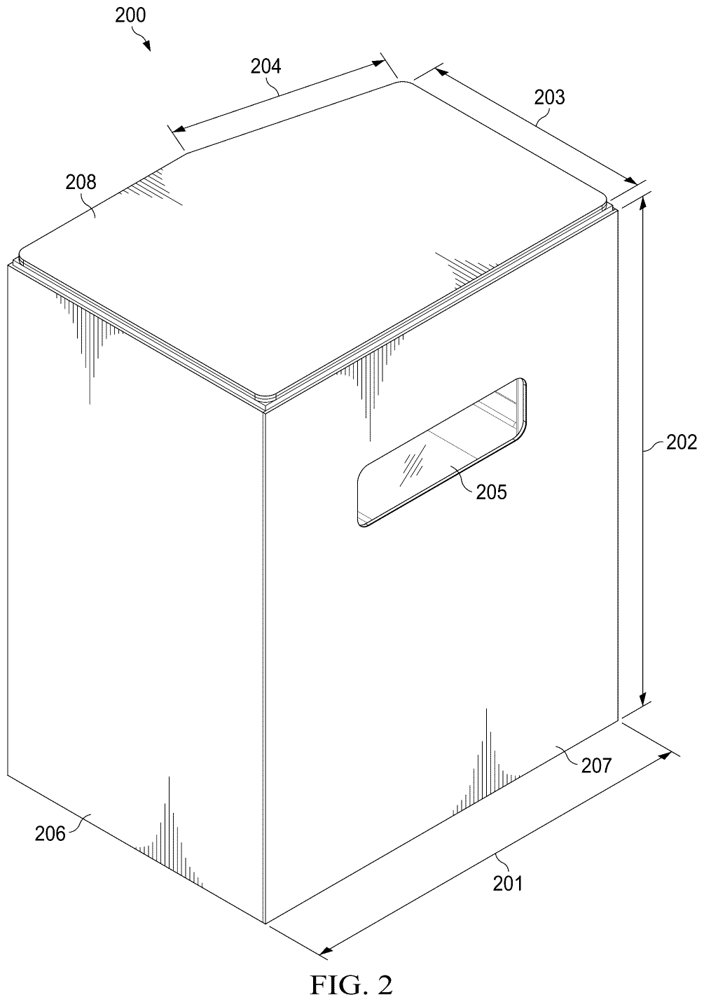

FIG. 2 shows a rear perspective view of the secure work pod exterior 200. The work pad has a length 201, height 202 and width 203. These dimensions are customizable as required for specific environments and office spaces. The angled front edge 204 is seen on the work pod ceiling 208. This is the angled edge seen over the front window panel in FIG. 1. The work pod has exterior acoustic panels that may be single as seen here for the side panel 206 and the rear panel 207, or the sides and rear of the work pod may have several smaller modular panels as described for FIG. 1. The rear panel 207 has a rear window 205 on the opposite side wall from the entrance to let natural light into the pod. The rear window may be left open or may be a semi-glazed window to allow more natural light to enter the work pod while still providing visual privacy for the user.

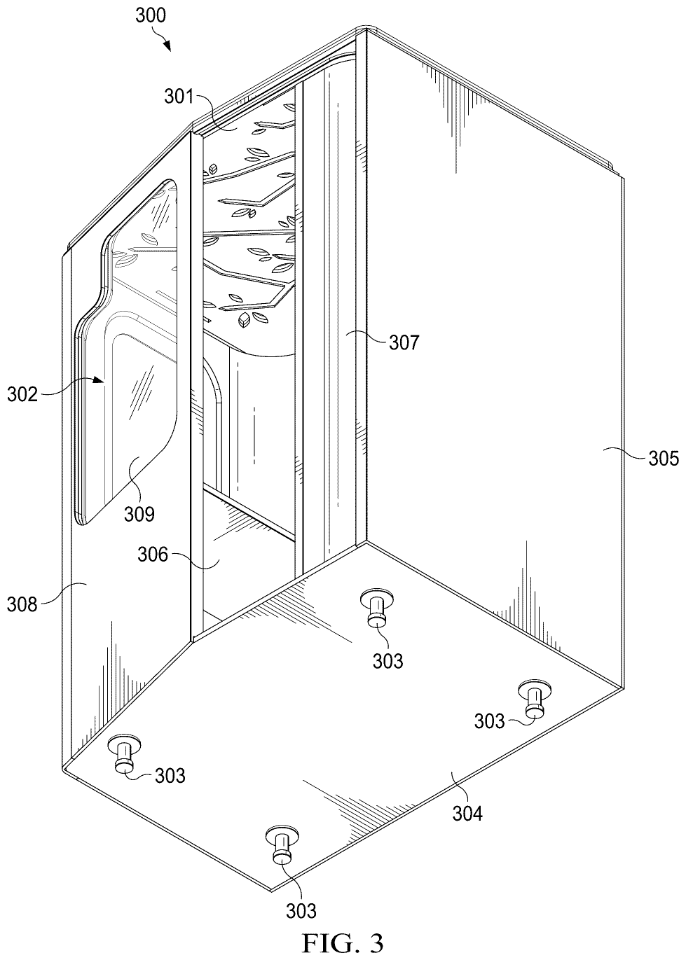

FIG. 3 shows a bottom perspective view of a secure work pod. In this figure, work pod 300 components including a floor panel 304, side panel 305, and a front panel 308 are visible. The floor panel 304 has four casters 303 which aid in moving and stabilizing the work pod. Caster types suitable for the work environment may be used, including but not limited to fixed casters, swivel casters and kingpinless casters. Casters may have swivel locks to facilitate straight line movement and have full lock to prevent movement once the work pod is in its location. In this figure, four casters are used; however, the number of casters used on the work pod and the materials for the caster wheels and mounts are selected based on the dimensions and weight of the work pod unit, and the environment in which the work pod will reside. Materials include, but are not limited to metals, such as iron or steel, synthetics, such as nylon, neoprene and polyurethane, and natural materials, such as rubber.

Also shown in FIG. 3 are interior features of the work pod. Looking through window 309 in front panel 308, a graze lighting unit 302 is visible on the side wall above the desk 306. Looking through the opening adjacent door 307, the underside of the integrated desk 306 and the underside of the ceiling panel 301 are visible. Int this figure, the ceiling panel has a design that may include openings to allow for light and ventilation in the work pod.

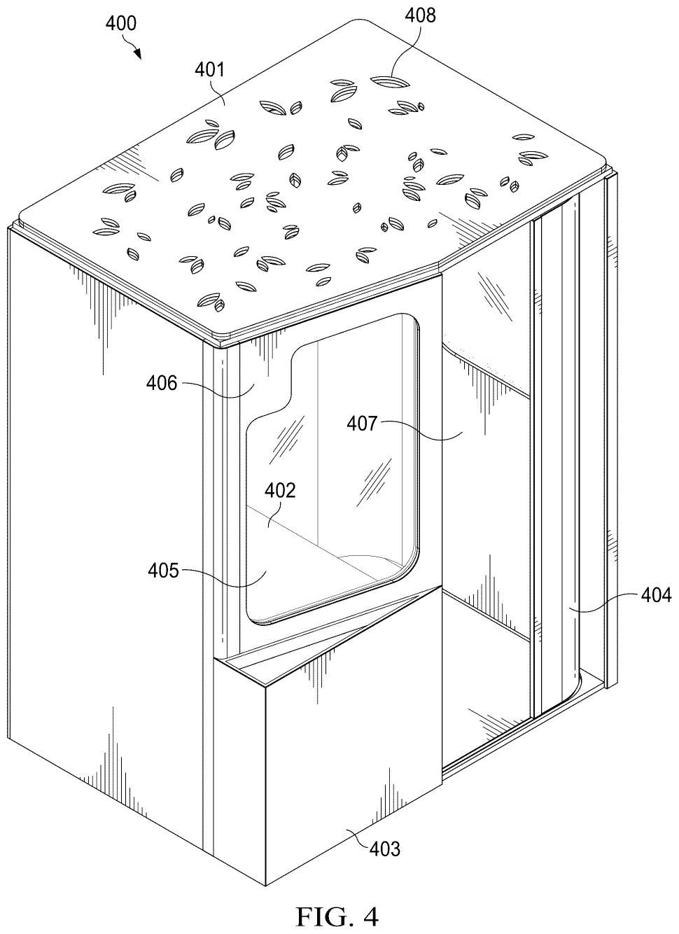

FIG. 4 shows another front perspective view of a secure work pod exterior with additional features that may be in the work pod. In this view of the work pod 400, the ceiling panel 401 is partially open by way of openings 408 through the ceiling panel. In this figure, the openings 408 are shaped like leaves and distributed in a pattern across the ceiling, but other shapes may be used depending on the desired aesthetics for the work pod. The sit/stand desk 402 is visible through window 405 in front panel 406. In this figure, a planter box 403 is situated beneath the window 405 in the front panel 406. The window box 406 functions as a storage compartment and may house an external planter box on top fitted with biophilia in a removable planter tray. An access control system and smart lock may be integrated into the storage compartment or planter box. The sliding pocket door 404 in the work pod 400 will slide into the space behind interior wall panel 407 when in the open position.

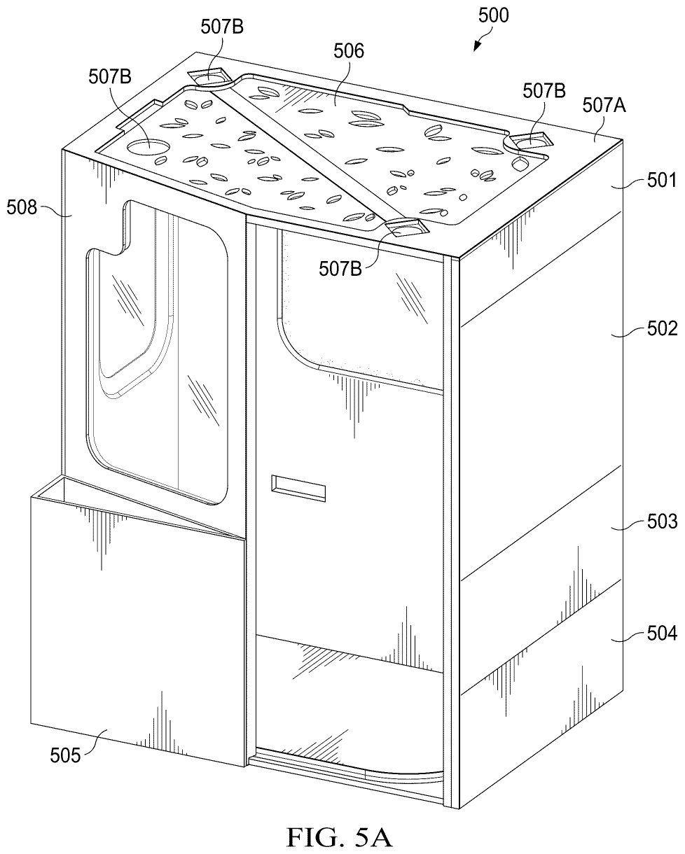

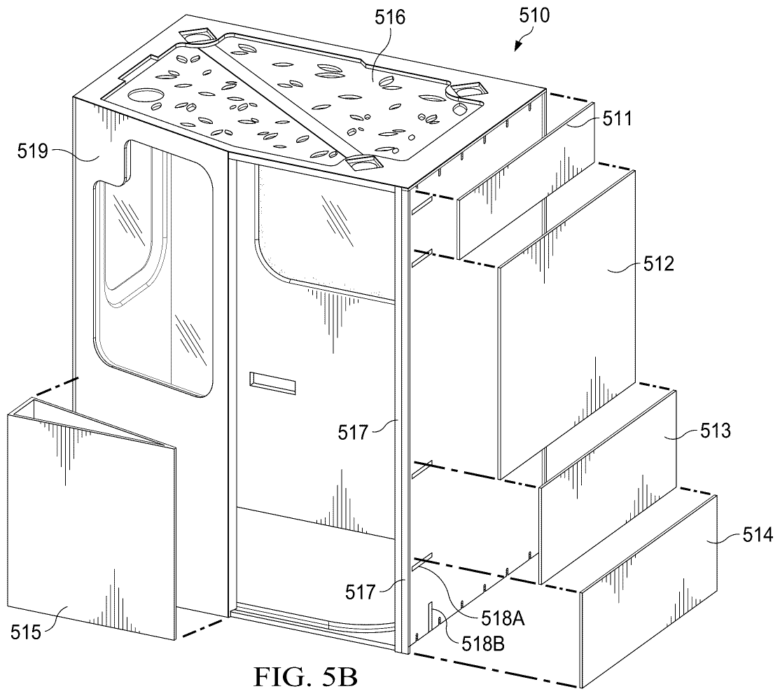

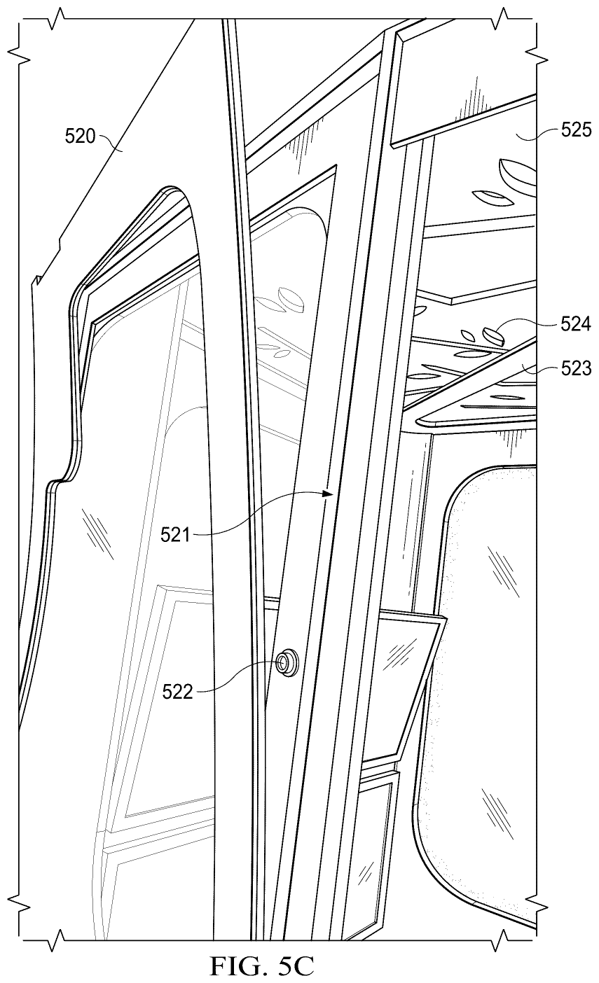

FIG. 5A shows a view of the work pod 500 with a series of acoustic side panels 501, 502, 503, 504, shown here in the intact positions. In this figure, the work pod has a single front panel 508 with a planter/storage box 505 attached. As shown here, the work pod has a partially open acoustic ceiling 506 with a design in the panel for ventilation and light. Ceiling connectors 507B are shown in the four corners of ceiling frame 507A for attaching the ceiling panel 506 to the work pod frame.

FIG. 5B shows an exploded view of the acoustic side panels 511, 512, 513, and 514 for the work pod 510. These side panels will be aligned with the channel edging 517 on the work pod frame. Panels shown here are attached to the frame via clip-type connectors which may be horizontal clip connectors 518A or vertical clip connectors 518B. In some environments, the panels may be attached to the frame by bolt-type connectors instead of or in addition to the clip connectors. In FIG. 5B, window box 515 is shown detached from the single front panel 519 of the work pod.

The modular functional panels for the work pods are available with a multitude of finish options which can be easily replaced. One or more panels can be used for each side of the work pod. In FIG. 5A, four differently sized panels 501, 502, 503, 504 are shown on the right side of the pod. With the impermanent nature of the interior and exterior paneling, ruined or disliked panels can be replaced as needed. In FIG. 5B the four side panels 511, 512, 513 and 514 are shown detached from the work pod and any of these panels can be easily removed if needed by detaching the panels from the clip connectors and installing new panels with the connectors.

The secure work pod system is adaptable and can be used with various types of materials for the panels, such as olyethylene terephthalate (PET) panels, laminated panels, and wood veneer panels for both interior and exterior of the unit. Multi-material options are usable for the panels including, but not limited to: PET, PET Fabric, High Pressure Laminates (HPL), Wood Veneer, and Vinyl Wrapped Panels. Ease of installation is achieved with a single-user attachment clip system for attaching the panels to the frame. The panels are removed and installed by hand. The clip system allows a single user to ‘snap’ the panels onto the unit frame using the integrated connection points.

FIG. 5C shows an enlargement of the work pod front with the acoustic front panel 520 and attachment means. The font panel 520 is shown slightly detached from the work pod frame. In this view the channel edging 521 of the frame is seen along with one of the clip type connectors 522, which in this figure is a round clip-type connector. FIG. 5C also shows an interior view of the ceiling. The ceiling framing 523 is shown, and in embodiments with an open ceiling, this type of framing forms the open top of the work pod. In this figure, a ceiling panel 525 is in place over the ceiling frame 523, with the ceiling panel 525 having design cut-outs forming a partially open ceiling for the work pod.

The modular panels on the sides and top of the secure work pod can be made of impact resistant materials which are easily replaceable. The panels are available in materials to suit various environments. These panels are fully replaceable, and comprise durable, impact resistant panels for high-traffic, high-wear locations.

The impact resistant panels surround and protect the structural integrity of the unit, prolonging the life of the secure work pod. Impact resistant panels also offer additional durability for the housing of devices, structures, enclosures, and equipment when placed in an environment that is subject to frequent wear. Panels can be easily replaced as needed if worn or damaged. In environments subject to harsher use conditions, such as in a warehouse, a bolt system can be used to secure panels in place instead of the clip-type system for pods situated inside office locations. A bolt system using a socket wrench for panel attachment simplifies the process of removal and replacement of the panels.

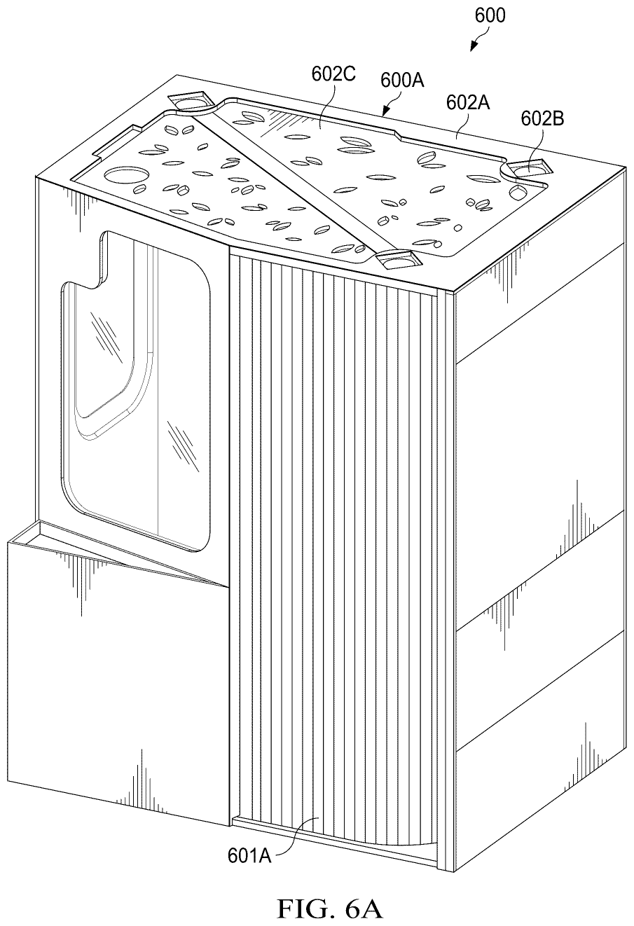

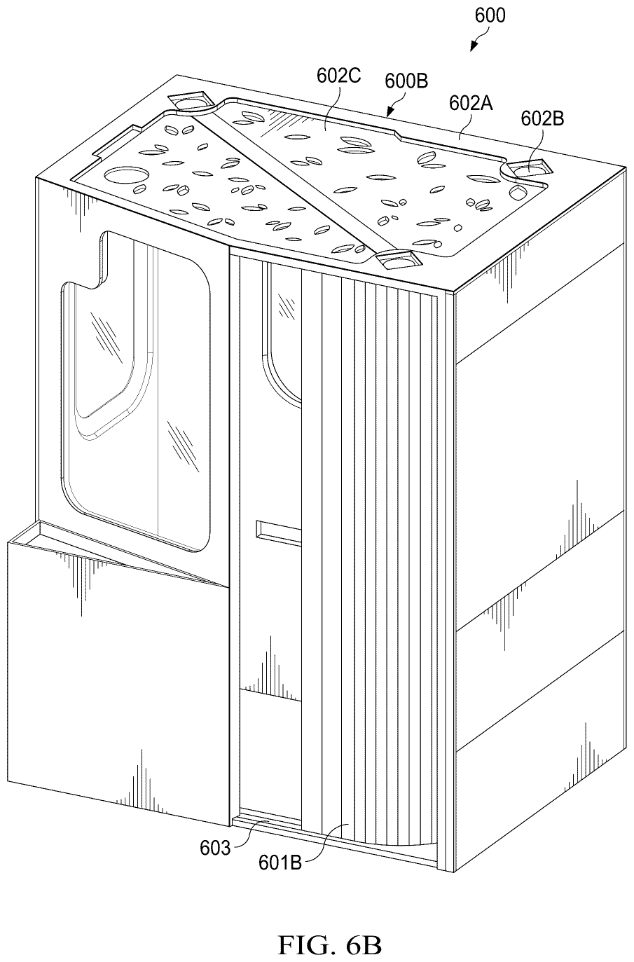

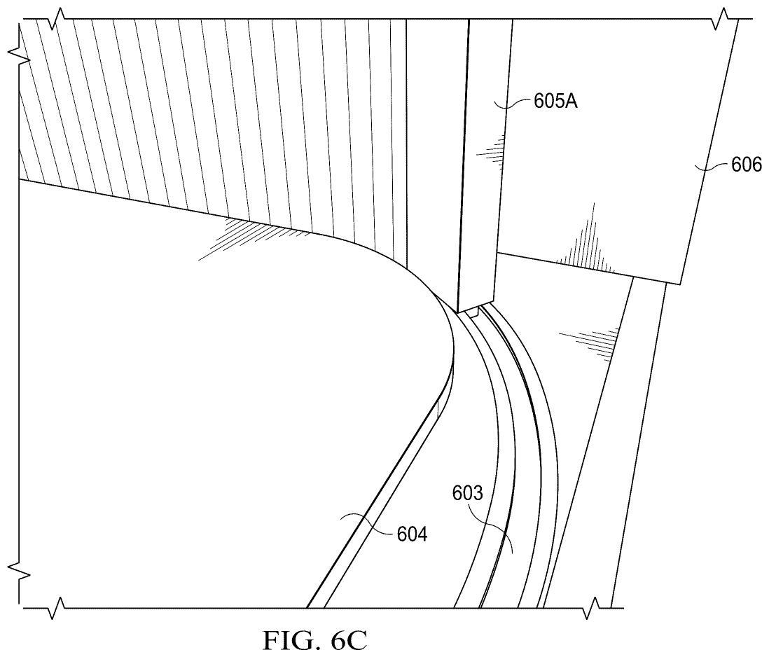

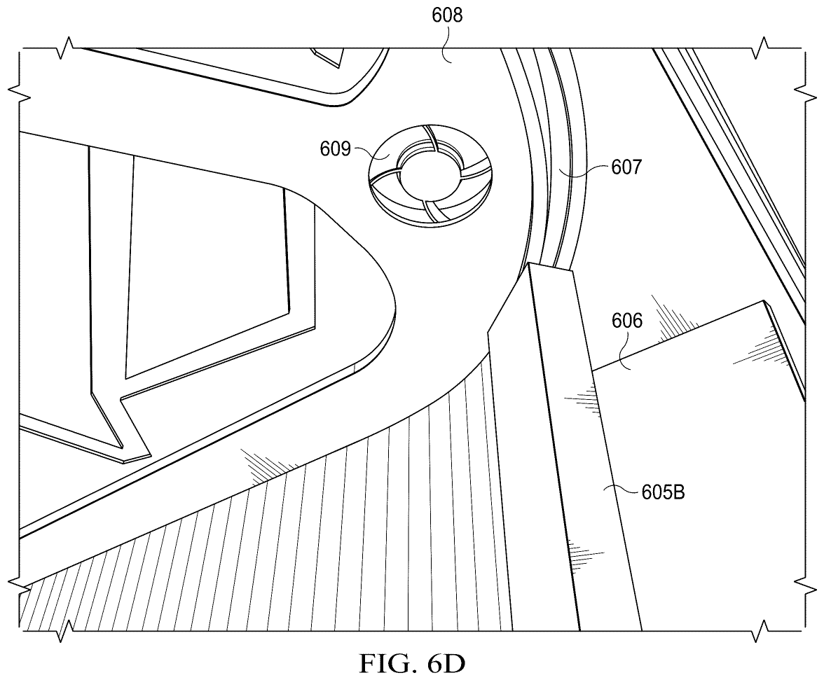

FIGS. 6A and 6B show a secure work pod 600 with the sliding acoustic door. In FIG. 6A, the work pod 600A shows the sliding acoustic door 601A in the closed position. FIG. 6B shows the work pod 600B with the sliding acoustic door 601B in the open position with the sliding acoustic door 601B moved along the bottom door track 603. In some embodiments, the acoustic sliding door 601B slides along the track 603 into a pocket area in the interior of the work pod. The sliding door can be stopped at any point along the track allowing the door to be fully open, partially opened, or fully closed. In the closed position, the door sits flush with the adjacent front wall panel and provides acoustical privacy for the user. The sliding door is also lockable providing security for the work pod contents when the user is away from the unit.

In FIGS. 6A and 6B, ceiling framing 602A is seen with ceiling connectors 602B seen in each corner on the top of the frame. A ceiling panel 602C with design cut-outs in the panel is seen attached to the ceiling frame 602A. In some embodiments having a fully open ceiling, the ceiling panel 602C is omitted and the ceiling frame 602A forms the top portion of the work pod.

FIG. 6C shows an enlargement of the bottom portion of the acoustic door and track with the door in the open position. The bottom edge of the acoustic sliding door 605A is situated in the bottom door track 603, which is curved to allow the door to slide open smoothly and to facilitate the door moving into the storage position inside of the work pod. The acoustic door is flexible enough to rotate inside the work pod when in the open position. The bottom door track 603 is positioned on the front edge of the work pod floor 604 and spans the width of the door curving towards the back of the work pod such that in the fully opened position, the sliding door rests coplanar to the side wall 606 behind the user. In some embodiments, the door slides into a space situated between the interior and exterior wall panels.

FIG. 6D show an enlargement of the top portion of the acoustic door and track with the door in the open position. The top edge of the acoustic sliding door 605B is situated in the top door track 607, which is curved like the bottom track to allow the door to slide open smoothly and to facilitate the door moving into the storage position inside of the work pod. The top door track is positioned on the front edge of the work pod ceiling frame 608 and spans the width of the door curving towards the back of the work pod such that in the fully opened position, the sliding door is positioned behind the user. An interior view of a ceiling connector 609 is seen on the ceiling frame 608 adjacent to the top door track 607.

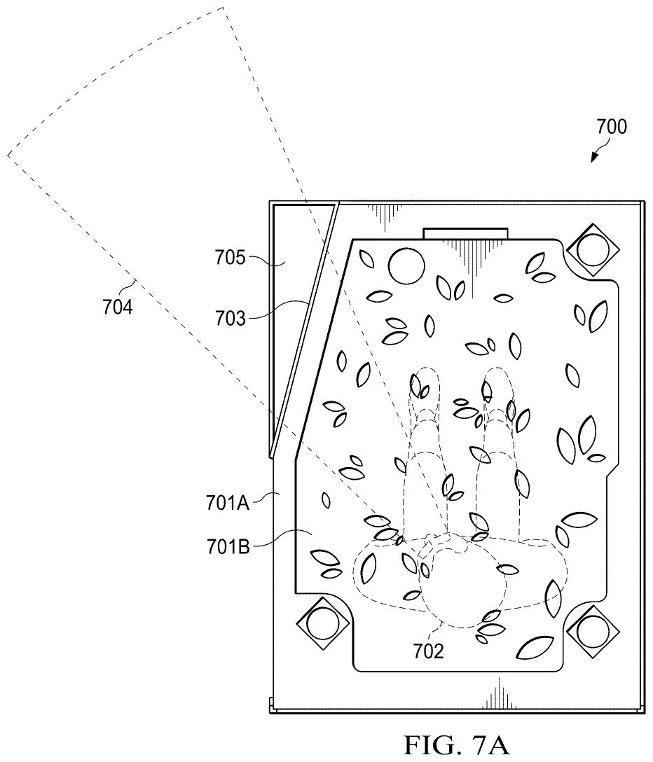

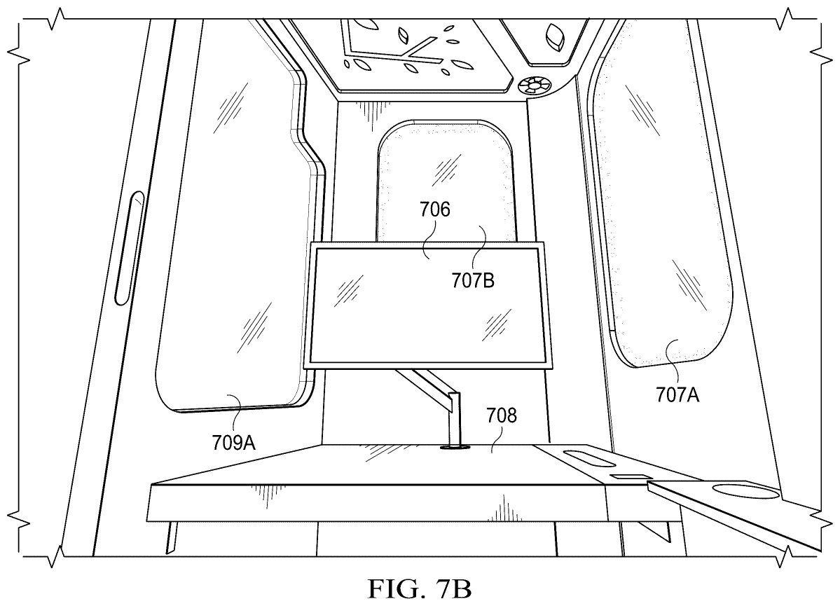

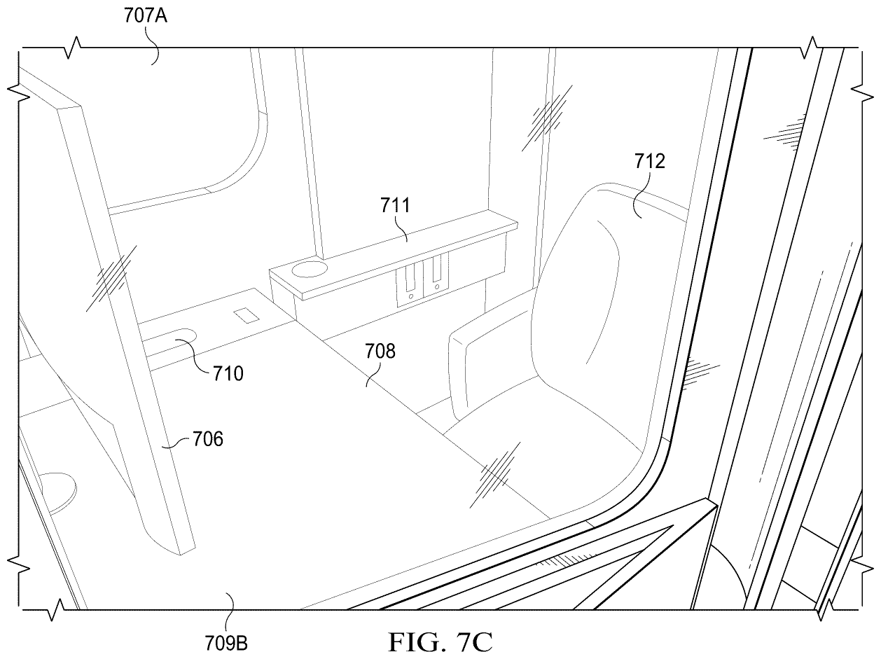

FIG. 7A shows a top view of the field of view angle 704 for a user 702 sitting in the work pod 700. The user 702 is facing the portion of the pod where the desk would be located. The window and door would be to the left of the user 702. The exterior walls of the pod act as a visual barrier providing privacy for the user inside of the pod. Visual privacy is augmented for the secure work pod 700 by way of the angled front panel 703. A window is positioned in the angled front panel 703 over the planter box feature 705. The angled front window on the front (door) side of the pod adjacent to the work desk allows the user to see out of the pod while working at the desk, even if the door is closed. This positioning not only allows the user 702 to see outside of the pod while working, the angled nature of the front panel also allows for the windows in a group of pods in a work environment to be oriented in such a way that the users in the group of pods will each have visibility outside of the pod without having a view into another pod. In the FIG. 7A top view, the partially open ceiling panel 701A and ceiling frame 701B are seen to follow the perimeter of the work pod including the angled portion of the front panel.

FIG. 7B shows a view of the interior of the work pod. This is the direction a user would face when positioned like the user 702 in FIG. 7A. A user would face the integrated desk 708 and monitor 706 when working inside the work pod. The window 709A seen from inside the pod, is positioned in the angled front panel, allowing a user to see out of the work pod with the line of sight angled like the front window. Graze lighting is positioned inside the work pod with a side positioned graze light 707A and a front positioned graze light 707B. Graze lighting inside the work pod provides soft light for the enclosed the work environment. The positioning of the graze lights 707A and 707B along with the angled view port window gives an open feeling to the work pod interior while maintaining the visual privacy feature of the work pod.

FIG. 7C shows a view into the work pod from the outside. Looking into the secure work pod from outside of the angled window 709B, the edge of the monitor 706 is visible, but the monitor screen is not visible. The desk 708 is positioned in front of the monitor and has a charging panel 710 integrated into the surface. This area of the desk may also have the controls to raise and lower the desk. One of the graze lights 707A is visible on the wall across from the angled window. A control console 711 is positioned on the rear wall of the work pod with controls for lighting color and intensity, and other user controllable features, such as “do not disturb” notifications for the pod or audio features. In some embodiments, the control console also has lockable storage for the user's personal items. A foldable chair 712 is integrated into the work pod interior.

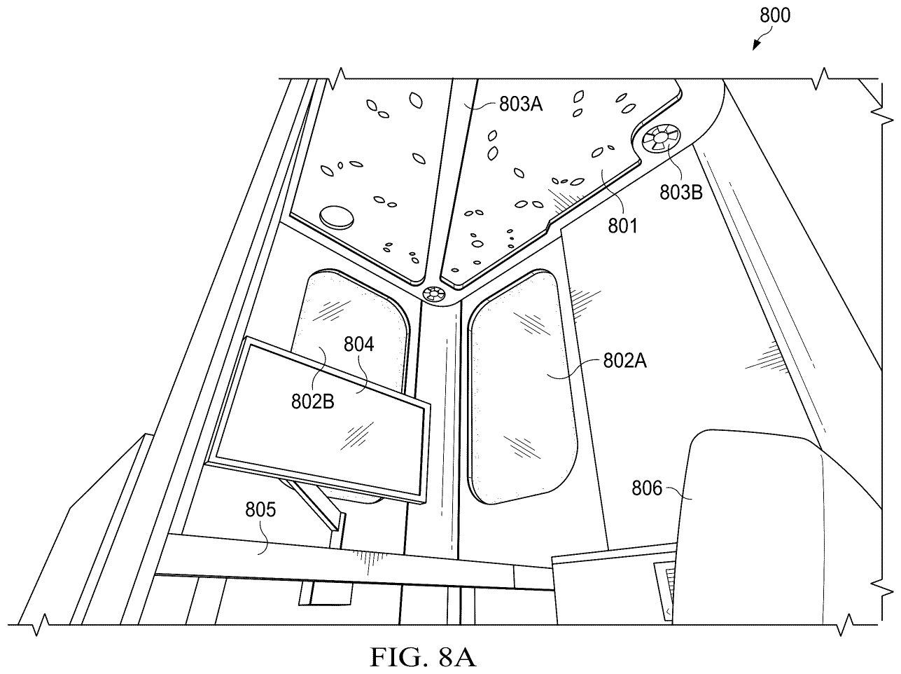

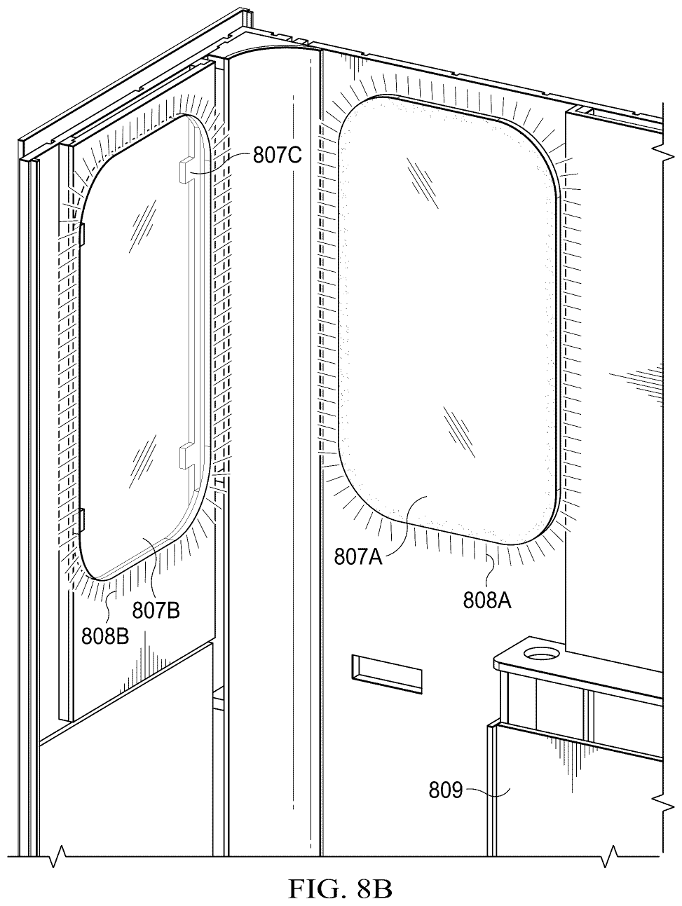

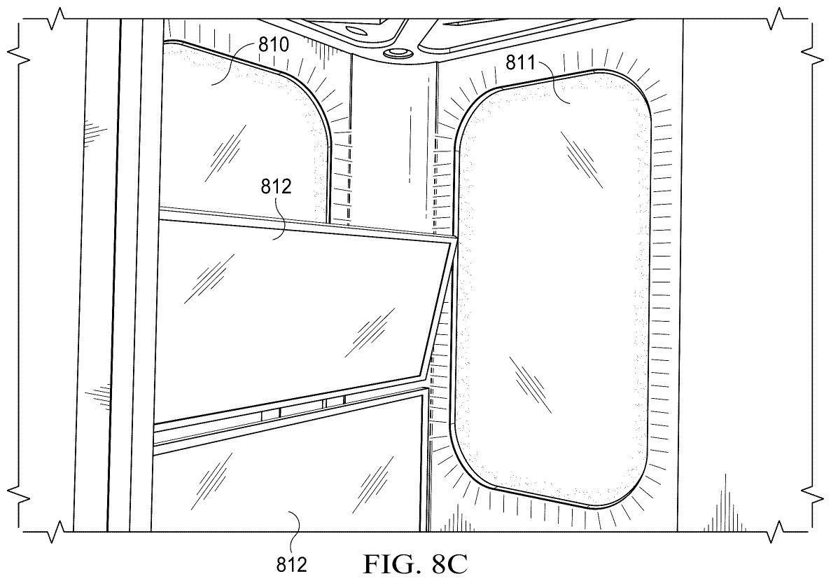

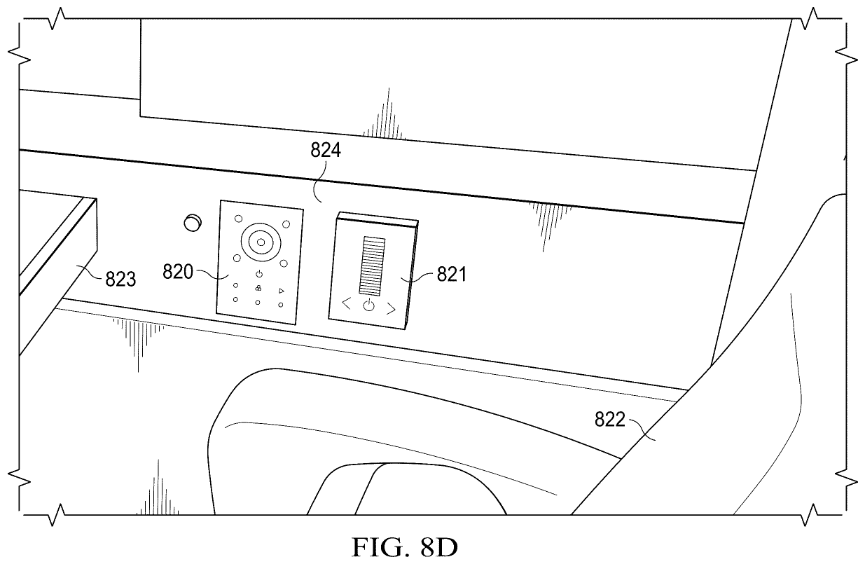

FIG. 8A shows interior lighting for a secure work pod. Pod interior 800 shows another view of the graze lighting used in the work pod interior 800. Graze lights positioned at the user's side 802A and front 802B provide bright but indirect light in the enclosed pod which allow adequate lighting for the chair 806, desk 805 and monitor 804 without causing glare on the surfaces. In pods where the ceiling has a partially open ceiling panel 801, outside lighting also enters the work pod through the openings. In some embodiments, a ceiling panel is not used and the ceiling frame 803 is the top portion of the work pod. When the ceiling frame 803 is used without a ceiling panel, much more light enters the work pod from the environment. The user can control the intensity and color of the graze lights inside of the work pod using the integrated control console.

FIG. 8B shows interior lighting components for the secure work pod. The graze lights are positioned to the side and in front of the user's work position in the pod and have reflection panels 807A and 807B that cover the light fixtures. From around the edges of the reflective panels, light is emitted 808A and 808B such the light grazes the walls, providing bright but indirect lighting for the work pod interior. Connectors 807C hold the reflective panels 807A and 807B securely to the work pods wall panels with a gapped area around the reflective panels to allow for light emission. Lighting for the work pod interior is controlled by the user with the control console 809 located on the panel wall beside the user's position in the work pod.

FIG. 8C shows placement of interior lighting for the secure work pod. The front graze light 810 is positioned in front of the user and behind the monitors 812 on the desk. The side graze light is positioned to the side of the user. With the graze lights in these positions, the work pod has sufficient light for working, but does not have any lights that are shining directly on the monitor screens.

FIG. 8D shows the control console 824 for interior components in the work pod. The control console may have multiple control units included in the control console, such as controls for lighting 820 and auditory 821 equipment. When working in the pod, the user would be positioned in the chair 822 in front of the desk 823, with the control console 824 placed within easy reach of the working position. In some embodiments, the top surface of the control panel functions as an integrated arm rest.

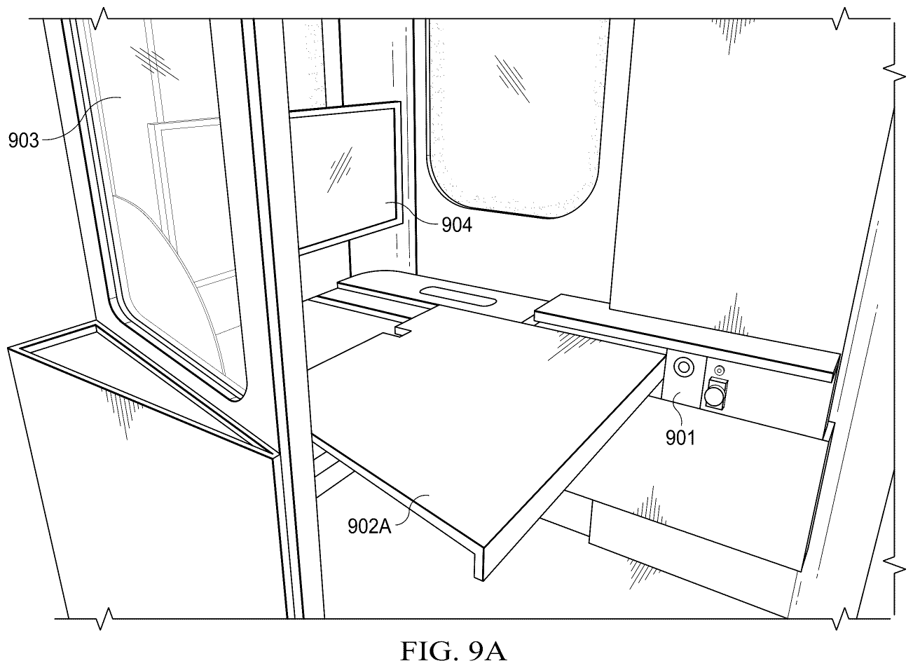

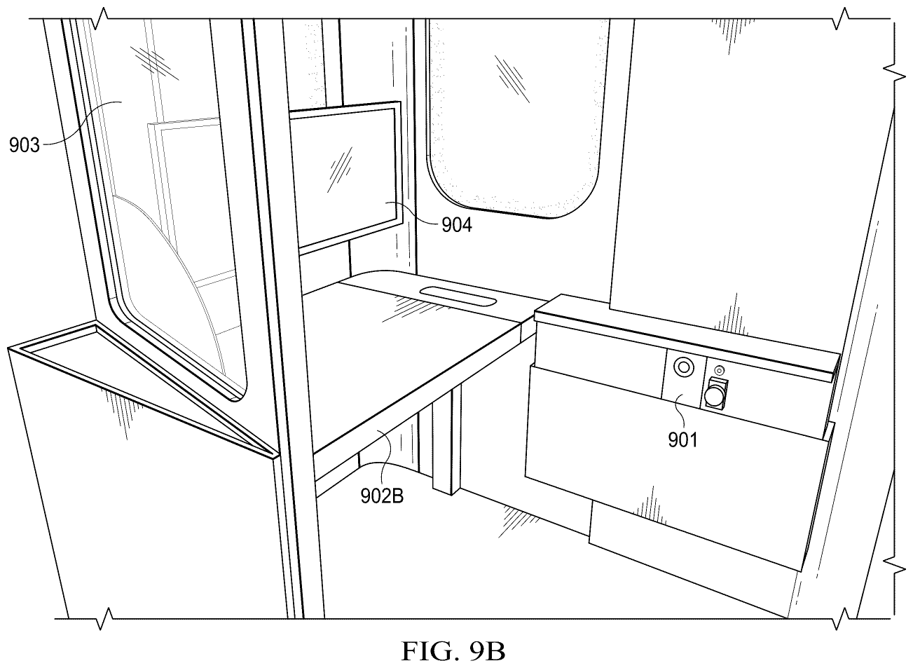

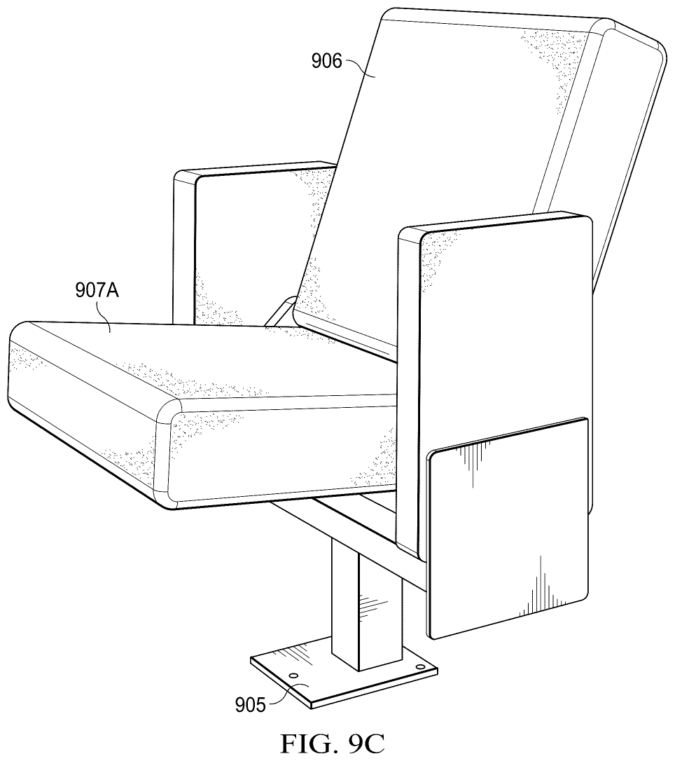

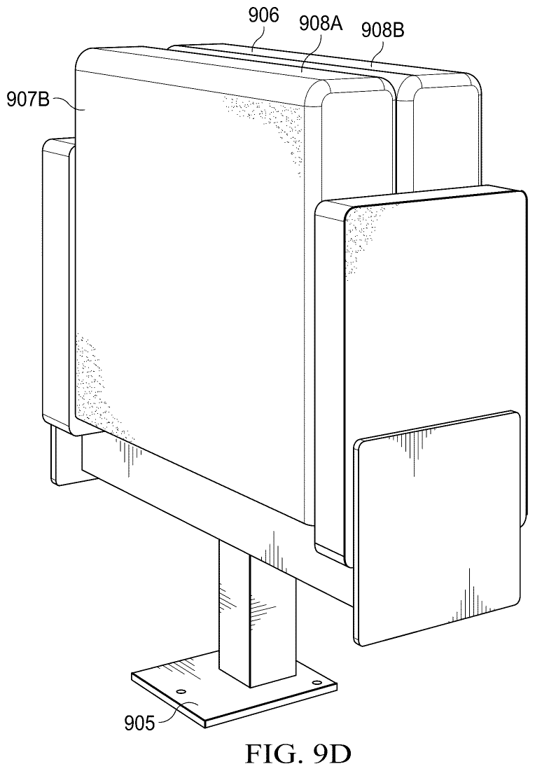

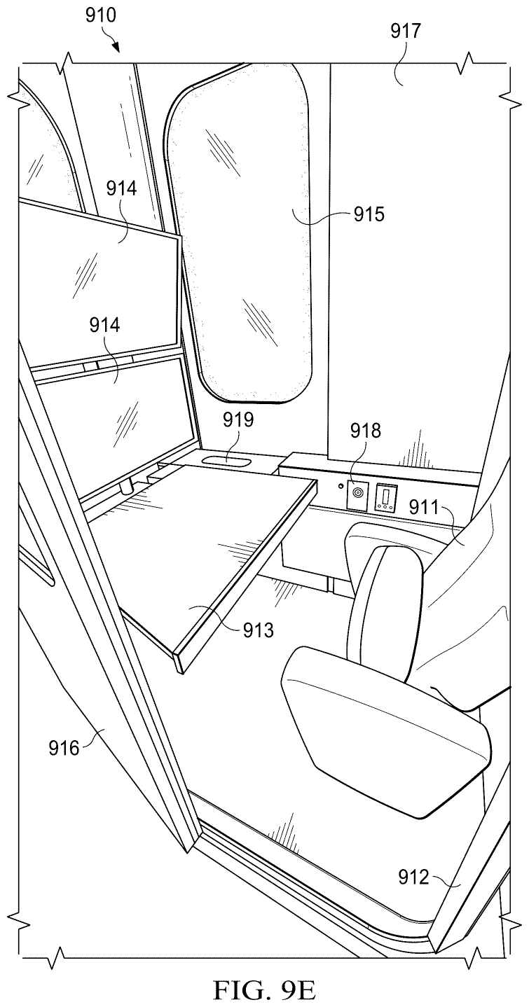

The secure work pod has an integrated sit/stand work desk that can slide open to an extended position providing more working surface or moving the desk closer to the user. The desk can also be used in a closed position if the extra space is not needed. FIG. 9A shows the work pod interior with the extended desk 902A reaching a stop point at the control console 901. From this position the user can still view the monitor 904 and see out of the angled window 903 in the front panel. FIG. 9B shows the work pod interior with desk closed 902B. From the closed position, the user can access the control console 901, view the monitor 904, and see out of the angled front window 903. The desk 902A, 902B can also be elevated to allow a user to work from the standing position, if desired. Monitors 904 are attached to the desk and will move with the desk to the standing position.

The secure work pod has an adjustable chair that can be used in conjunction with the sit/stand desk. FIG. 9C shows a work pod chair 906 with the open seat position 907A as the chair would be used if the pod user is sitting at the desk to work. The chair is secured to the work pod floor by a floor plate 905. FIG. 9D shows the work pod chair 906 with closed seat position 907B. When the chair seat is in the closed position 907B, the front edge of the seat 908A and the top edge of the chair back 908B align to make a seat for the user to comfortably work in the standing position. With the chair securely attached with floor plate 905, the folded chair is stable for use as a standing work chair.

FIG. 9E shows a work pod interior with the desk and chair in place. The interior is a compact composition with all the elements needed for the user to be comfortably situated in an acoustically controlled workspace. The work pod interior 910 shows the foldable chair 911 situated between the sliding acoustic door 912 on the front side of the work pod and the control console 918 on rear panel 917 of the work pod. The sliding door 912 is in the opened position with the sliding door stored in the space behind the user's chair 911. The extendable sit/stand desk 913 is positioned in front of the chair and has the charging port 919 on the right side of the desk. Monitors 914 are attached to the sit/stand desk 913. In this view, 2 monitors 914 are stacked on the top of the desk 913. The desk 913 is positioned between the angled front panel 916 and the graze light 915 on the rear panel 917 of the pod.

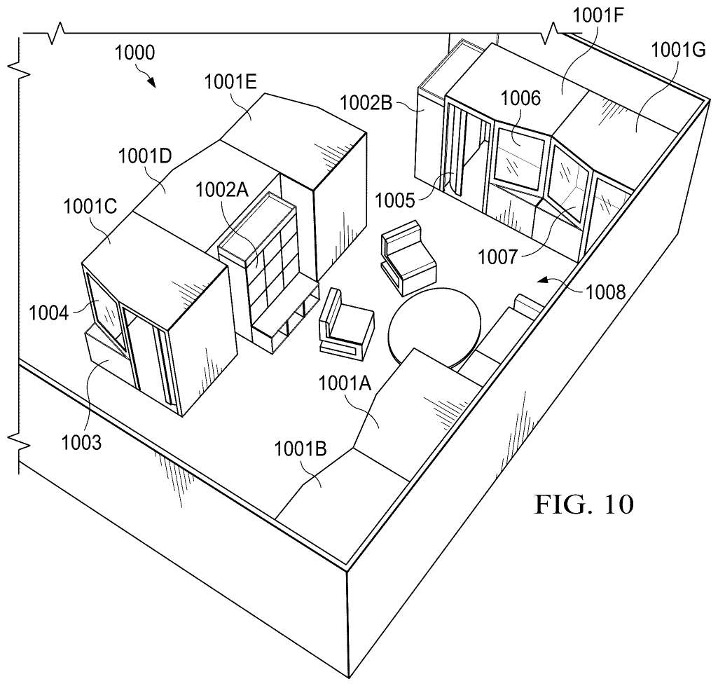

FIG. 10 shows an example of a multi-pod neighborhood layout. This multi-pod neighborhood 1000 has seven work pods 1001A-1001G. Work pods 1001A-1001G are positioned around a common area 1008 which has a seating area. The multi-pod neighborhood has two locker banks 1002A, 1002B for secure storage of users' personal items. Each work pod has an angled front panel which allows for visual privacy within the work pod setting. Work pods 1001F and 1001G are positioned next to each other with the windows in the front panels 1006, 1007 angled so that the line of sight from the two pods would be across the common area 1008 and not into any other pods. Similar positioning is used for work pods 1001A and 1001B and users in these pods would not have a view into any other pods. Work pods 1001 C, 1001D and 1001e are adjacent to each other and the positions of the angled front panels allow each pod to have a line of sight that does not include a neighboring pod. A planter box 1003 is shown on work Pod 1001C underneath the window 1004. In a neighborhood with several work pods, the common areas and the planter boxes with biophilia would provide a pleasing environment for the work pod neighborhood.

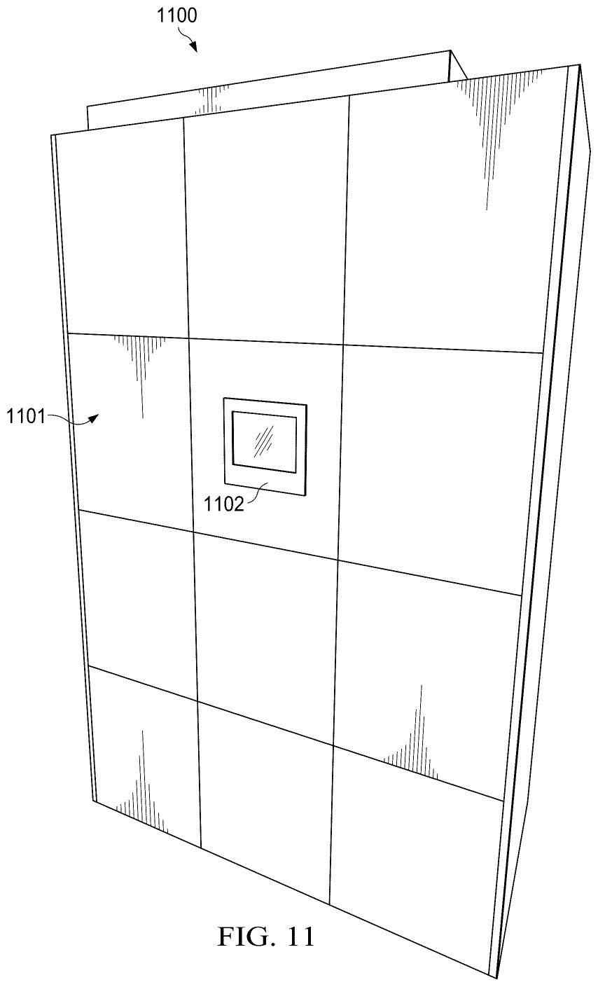

FIG. 11 shows a locker bank for a work pod neighborhood. The locker bank 1100 has multiple compartments 1101 that have smartlock capabilities. The smartlock compartments are accessed with credentials entered in the access panel 1002 located on the locker bank. Smartlocks can be accessed via credentials entered manually, such as an alpha-numeric combination, via Wi-Fi access from a personal mobile device, via a swipe or tap card or fob, or via a response received to a request entered at the access terminal.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention; and, in fact, while the invention has been described, disclosed, illustrated and shown in various terms of certain embodiments or modifications which it has presumed in practice, the scope of the invention is not intended to be, nor should it be deemed to be, limited thereby, and such other modifications or embodiments as may be suggested by the teachings herein are particularly reserved, especially as they fall within the breadth and scope of the claims here appended.

1. A secure work pod comprising a moveable, personal office space having,
a plurality of exterior wall panels, said plurality of wall panels having a back wall panel, a right side wall panel, a left side wall panel and a front wall panel, said front wall panel being substantially half the length of the back wall panel and having a window opening;
a plurality of interior wall panels, said plurality of wall panels having a back wall panel, a right side wall panel, a left side wall panel and a front wall panel, said front wall panel being substantially half the length of the back wall panel and having a window opening;
a horizontal floor panel having a left side edge, a right side edge, a back side edge and a front side having an angled front edge and a straight front edge, said left side edge, said right side edge, said back side edge and said straight front edge being substantially perpendicular to one another; and
a horizontal ceiling frame having a left side edge, a right side edge, a back side edge and a front side having an angled front edge and a straight front edge, said left side edge, said right side edge, said back side edge and said straight front edge being substantially perpendicular to one another;
a channel framing structure having a plurality of construction connectors to attach the wall panels, floor panel and ceiling frame to the channel framing structure for construction of the secure work pod,
wherein the interior and exterior vertical front wall panels are positioned coplanar on the channel framing structure between the angled portion of the horizontal floor panel and the angled portion of the horizontal ceiling frame such that the front panels of the work pod are angled and the front wall panels are adjacent to either the panels on the right side or the panels of the left side, said angled front wall panel orientation providing visual privacy to the pod interior through the window in the front panels, and
wherein the interior and exterior back panels, right side panels and left side panels are coplanar and the vertical edges of the interior and exterior back panels, right side panels and left side panels are secured to the channel framing structure adjacent to one another having substantially perpendicular connections at the vertical edges;
wherein all of the wall panels are substantially of a same height being secured to the channel framing structure perpendicular to said floor panel and said ceiling frame,
a doorway opening encompassing the space between the angled front panel and the adjacent left side panel or adjacent right side panel, said half-length of said front panel providing said doorway opening adjacent to the front panel,
a door positioned in the doorway opening and attached to the secure work pod,
a desk integrated into the interior of the work pod positioned between the angled front panel and the back panel, said desk being substantially parallel to the adjacent side wall;
a chair secured to the horizontal floor panel, said chair having a stationary back member and a foldable seat member, said foldable seat member capable of being folded towards the stationary back member; and
a control panel attached to the back wall panel, said control panel housing controls for environmental conditions in the work pod.

2. The secure work pod of claim 1, wherein the exterior wall panels comprise a single vertical panel, a plurality of adjacent vertical panel sections or a plurality of adjacent horizontal panel sections that are changeable and replaceable.

3. The secure work pod of claim 2 wherein one or more of the window openings have glass windowpanes, plastic windowpanes, or switchable smartglass windowpanes in the openings.

4. The secure work pod of claim 1, wherein the doorway has a moveable door that opens and closes.

5. The secure work pod of claim 4, wherein the moveable door is a sliding door comprised of acoustic materials for sound regulation.

6. The secure work pod of claim 1, wherein the ceiling is partially open with an acoustic panel secured to the horizontal ceiling frame.

7. The secure work pod of claim 1, wherein the integrated desk is vertically moveable for use in a seated or a standing position and horizontally moveable toward the secured chair.

8. The secure work pod of claim 1, wherein the foldable seat member folds towards the stationary back such that the front edge of the seat member and the top edge of the stationary back member form a seating platform for a user.

9. The secure work pod of claim 1, wherein the secure work pod has drop in wiring connectors to provide power to the pod interior.

10. The secure work pod of claim 1, wherein the secure work pod has locking casters on the bottom for moving the work pod and to secure the work pod in position.

11. The secure work pod of claim 1, wherein connectors are positioned on the exterior panels, said connectors are able to securely connect one or more pods together in a multi-pod work layout.

12. The secure work pod of claim 1, wherein a triangular shaped compartment is removably secured to the exterior angled front panel underneath the window opening, said triangular shaped compartment having an integrated storage area and a removable top tray portion, said triangular shaped compartment is sized such that the front edge and side edge of the triangular shaped compartment are coextensive and perpendicular to the edges of the adjacent wall panels.

13. A method of constructing a secure work pod comprising the steps of:
providing a channel framing structure having interior facing and exterior facing portions with a plurality of construction connectors positioned on the members for fastening interior and exterior panels to the framing structure, said framing structure having vertical members for securing vertical wall panels, top horizontal members for securing a ceiling frame at the top of the frame and bottom horizontal members for securing a floor panel;
providing a horizontal floor panel having a front edge with an angled portion and a straight portion, and having perpendicular edges on the right side, left side and back side of the floor panel;
providing a horizontal ceiling frame having front edge with an angled portion and a straight portion, and having perpendicular edges on the right side, left side and back side;
providing a plurality of exterior wall panels, said plurality of exterior wall panels having a back wall panel, a right side wall panel, a left side wall panel and a front wall panel, said front wall panel having a window opening and being substantially half the length of the back wall panel providing a doorway opening on the front of the secure work pod;
providing a plurality of interior wall panels, said plurality of interior wall panels having a back wall panel, a right side wall panel, a left side wall panel and a front wall panel, said front wall panel having a window opening and being substantially half the length of the back wall panel providing a doorway opening on the front of the secure work pod coplanar with the doorway opening the exterior front wall panel;
providing drop in electrical components to provide power to the secure work pod interior;
securing the horizontal floor panel to the bottom horizontal members of the frame structure with the construction connectors;
securing the horizontal ceiling frame to the top horizontal members of the frame structure with the construction connectors;
attaching the interior wall panels to the interior facing portion of the frame structure;
attaching the drop-in wiring connectors to the back panel adjacent to a location for a power outlet strip for the work pod interior for powering lights and equipment; and
attaching the exterior wall panels to the exterior facing portion of the frame structure using the construction connectors.

14. The method of claim 13 further comprising the step of:
installing one or more windowpanes in the window opening, said windowpanes being glass windowpanes, plastic windowpanes, switchable smartglass windowpanes, or a combination thereof.

15. The method of claim 13 further comprising the step of:
installing a moveable door in the doorway opening of the front panel that opens and closes.

16. The method of claim 15 wherein the moveable door is a sliding door made of acoustic materials for sound regulation, said sliding door having top and bottom tracks for opening and closing movement of the door, said sliding door when closed is positioned adjacent to the front panel and the sliding door when opened is positioned inside the secure work pod behind the user along the side wall.

17. A method for structuring a secure work pod environment comprising the steps of:
providing a plurality of assembled secure work pods, each of said plurality of assembled secure work pods having:
a ceiling frame, a ceiling panel, or a combination thereof;
a floor panel, said floor panel having a plurality of lockable casters for moving and securing said assembled secure work pod,
a front side with a window opening, a left side, a right side, and a back side, said front side, back side, left side and right said having wall panels, said front side being positioned at an angle relative to either the left side or the right side of the secure work pod, and
a doorway opening adjacent the angled front side;
providing construction connectors on the exterior of the plurality of secure work pods;
providing one or more banks of lockable storage compartments, said banks of lockable storage compartments having construction connectors compatible with construction connectors on assembled secure work pods;
positioning said assembled secure work pods adjacent to one another such that said angled front side with said window opening of a first secure work pod is directed away from said angled front sides with said window openings of one or more adjacent work pods, said positioning providing visual privacy for the secure work pod interiors;
connecting assembled secure work pods with said construction connectors on said left side, said right side, or said back side to construct a secure work pod cluster having two or more secure work pods with windows angled to provide for visual privacy; and
connecting said one or more banks of lockable storage compartments with said construction connectors to one or more of the secure work pods in the work pod cluster forming a work pod block.

18. The method of claim 17 wherein two or more work pod clusters or work pod blocks are positioned to provide visual privacy for each secure work pod front window and to facilitate access for users to one or more of said connected lockable storage compartments.

19. The method of claim 17 wherein said secure work pod clusters or work pod blocks are organized around a common use area in a workplace environment.

20. The method of claim 17 wherein one or more lockable storage compartments in said one or more banks of lockable storage compartments have electronic locks with accessibility that can be assigned to a user on a short term or a long-term basis.

21. The method of claim 17 further comprising providing lockable sliding doors in the doorway openings of the assembled secure work pods, said sliding doors being made of acoustic materials for sound regulation.

22. The method of claim 17 further comprising providing ceiling panels having acoustic materials for sound regulation in the secure work pods.
